(19) United States
(12) Patent Application Publication
(10) Pub. No.: US 2026/0270564 A1
(43) Pub. Date: Sep. 10, 2026

(54) METHOD AND SYSTEM FOR MULTI-EXPOSURE HDR IMAGING INCORPORATING HALLUCINATION TECHNIQUE

(71) Applicant: Varjo Technologies Oy, Helsinki (FI)

(72) Inventor: Mikko Ollila, Tampere (FI)

(73) Assignee: Varjo Technologies Oy, Helsinki (FI)

(21) Appl. No.: 19/073,400

(22) Filed: Mar. 7, 2025

(51) Int. Cl. H04N 23/741; G06T 5/50; G06T 5/60; H04N 23/73

(52) U.S. Cl. CPC H04N 23/741; G06T 5/50; G06T 5/60; H04N 23/73; G06T 2207/10144; G06T 2207/20208

(57) ABSTRACT

A method for multi-exposure high dynamic range (HDR) imaging. The method includes: receiving an input sequence of images captured by camera(s), wherein the images of the input sequence are captured using one or more exposures; applying a hallucination technique on one or more images of the input sequence, for generating a hallucinated set of images corresponding to a target exposure that lies within a target exposure (TE) range; and generating an output sequence of HDR images at a same frame rate as the input sequence, by employing a first neural network, each HDR image being generated using at least a previously-generated HDR image and one of: a corresponding image from the hallucinated set, a corresponding image from the input sequence.

### TECHNICAL FIELD

The present disclosure relates to methods for multi-exposure high imaging incorporating hallucination techniques. The present disclosure also relates to systems for multi-exposure high imaging incorporating hallucination techniques.

### BACKGROUND

Video see-through systems, commonly used in wearable devices (such as extended-reality (XR) devices), face significant limitations compared to a human visual system. One major limitation is a lack of high dynamic range (HDR) imaging capabilities, which significantly reduces an immersive experience for users. The HDR imaging requires capturing a broader range of brightness levels, but implementing this in the video see-through systems presents several challenges.

To achieve HDR, image sensors typically need to operate at least twice a standard frame rate. Such a requirement reduces a maximum possible exposure time while capturing an image, which subsequently produces a noise in said image. Additionally, a high frame rate demands result in increased data rates of an image sensor, which in turn results in significantly high power consumption, high data throughput requirements, and increased operational costs. Furthermore, an interface or analog-to-digital converter (ADC) speed can also become a bottleneck, as video see-through systems are required to generate high visual quality images along with fulfilling other requirements in the XR devices, for example, such as a high resolution (such as a resolution higher than or equal to 60 pixels per degree), a small pixel size, a large field of view, and a high frame rate (such as a frame rate higher than or equal to 90 FPS).

Existing multi-exposure HDR systems, which alternate between long and short exposure images to create a single HDR image, are well-known. However, such systems inherently require doubling a frame rate of the image sensor or image signal processor (ISP), which exacerbates the aforementioned issues. Higher frame rates are also crucial for maintaining a low latency as excessive latency can contribute to motion sickness, particularly in video see-through systems. As a result, existing solutions struggle to balance HDR performance with constraints of the video pass-through systems, for example, such as a power efficiency, a high resolution, a need for low latency, and a high frame rate.

Therefore, in light of the foregoing discussion, there exists a need to overcome the aforementioned drawbacks.

### SUMMARY

The present disclosure seeks to provide a method and a system that facilitate in generating high dynamic range (HDR) images at a same frame rate with which images of an input sequence are captured by camera(s), in a computationally-efficient and time-efficient manner. The aim of the present disclosure is achieved by a method and a system for multi-exposure HDR imaging incorporating hallucination technique, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for multi-exposure high dynamic range (HDR) imaging, in accordance with an embodiment of the present disclosure;

FIG. 2 illustrates a block diagram of a system for multi-exposure high dynamic range (HDR) imaging, in accordance with an embodiment of the present disclosure; and

FIGS. 3, 4, and 5 illustrate exemplary implementations of the method for multi-exposure high dynamic range (HDR) imaging, in accordance with various embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method for multi-exposure high dynamic range (HDR) imaging, the method comprising:
receiving an input sequence of images captured by at least one camera, wherein the images of the input sequence are captured using one or more exposures;
applying a hallucination technique on one or more images of the input sequence, for generating a hallucinated set of images corresponding to a target exposure that lies within a target exposure range; and
generating an output sequence of HDR images at a same frame rate with which the input sequence is captured, by employing a first neural network, each HDR image in the output sequence being generated using at least a previously-generated HDR image and one of: a corresponding image from the hallucinated set, a corresponding image from the input sequence.

In a second aspect, an embodiment of the present disclosure provides a system for multi-exposure high dynamic range (HDR) imaging, wherein the system comprises:
at least one camera; and
at least one processor configured to:
   receive an input sequence of images captured by the at least one camera, wherein the images of the input sequence are captured using one or more exposures;
   apply a hallucination technique on one or more images of the input sequence, for generating a hallucinated set of images corresponding to a target exposure that lies within a target exposure range; and
   generate an output sequence of HDR images at a same frame rate with which the input sequence is captured, by employing a first neural network, each HDR image in the output sequence being generated using at least a previously-generated HDR image and one of: a corresponding image from the hallucinated set, a corresponding image from the input sequence.

The present disclosure provides the aforementioned method and the aforementioned system that facilitate in generating HDR images at the same frame rate with which the images of the input sequence are captured by the at least one camera, in a computationally-efficient and time-efficient manner. Instead of utilising two or more captured images for generating a given HDR image (as in the prior art), pursuant to embodiments of the present disclosure, at least the previously-generated HDR image and the one of: the corresponding image from the hallucinated set, the corresponding image from the input sequence, are utilised for generating the given HDR image. This allows for generating the HDR images without affecting a frame rate negatively i.e., a frame rate of generating the HDR images is same as a frame rate of capturing the images by using the at least one camera. This is possible because when the hallucination technique is applied to a given image of the input sequence (captured using a given exposure), a resulting image that belongs to the hallucinated set is significantly similar to an image that may actually be captured using an exposure that is different from the given exposure. Due to this, the given image of the input sequence and the resulting image belonging to the hallucinated set serve as two images representing a same real-world scene, but having different exposures. Thus, the given HDR image can be generated using at least the previously-generated HDR image and one of: the given image of the input sequence, the resulting image belonging to the hallucinated set. Beneficially, there is no frame rate drop in generating the HDR image, unlike in the prior art where at least two captured images are used for generating each HDR image, resulting in a frame rate drop of, for example, ½ or ⅓.

For illustration purposes, there will now be described how various components of the aforementioned system can be implemented. The at least one processor controls an overall operation of the system. The at least one processor is communicably coupled to the at least one camera. Optionally, the at least one processor is implemented as a processor of a head-mounted display (HMD) device. The term “head-mounted display” device refers to specialized equipment that is configured to present an extended-reality (XR) environment to a user when said HMD device, in operation, is worn by the user on his/her head. The HMD device is implemented, for example, as an XR headset, a pair of XR glasses, and the like, that is operable to display a visual scene of the XR environment to the user. The term “extended-reality” encompasses augmented reality (AR), mixed reality (MR), and the like. Alternatively, optionally, the at least one processor is implemented as a processor of a computing device. The computing device is optionally communicably coupled to the HMD device. Examples of the computing device include, but are not limited to, a laptop, a desktop, a tablet, a phablet, a personal digital assistant, a workstation, and a console. Yet alternatively, optionally, the at least one processor is implemented as a cloud server (namely, a remote server) that provides a cloud computing service.

Optionally, the at least one camera comprises at least one visible-light camera. Examples of such a visible-light camera include, but are not limited to, a Red-Green-Blue (RGB) camera, a Red-Green-Blue-Alpha (RGB-A) camera, a Red-Green-Blue-Depth (RGB-D) camera, a Red-Green-Blue-White (RGBW) camera, a Red-Yellow-Yellow-Blue (RYYB) camera, a Red-Green-Green-Blue (RGGB) camera, a Red-Clear-Clear-Blue (RCCB) camera, a Red-Green-Blue-Infrared (RGB-IR) camera, and a monochrome camera. Additionally, optionally, the at least one camera further comprises at least one depth camera. Examples of such a depth camera include, but are not limited to, a Time-of-Flight (ToF) camera, a light detection and ranging (LiDAR) camera, a Red-Green-Blue-Depth (RGB-D) camera, a laser rangefinder, a stereo camera, a plenoptic camera, a ranging camera, a Sound Navigation and Ranging (SONAR) camera.

It will be appreciated that the at least one camera captures the images at a given frame rate, for example, such as 30 frames per second (FPS), 60 FPS, 90 FPS, or similar. An image capturing operation is well-known in the art. Notably, when a given image is captured using a given exposure, it means that the given image is captured using a combination of values of an exposure time, a sensitivity, and an aperture size. Thus, a values of the given exposure changes with a change in a value of at least one of: the exposure time, the sensitivity, the aperture size. The exposure time, the sensitivity, and the aperture size are well-known in the art. It will be appreciated that a same exposure can be achieved by employing multiple combinations of the values of the exposure time, the sensitivity, and the aperture size. As an example, an exposure having an exposure value of 10 may be achieved by employing any one of: (i) an exposure time of 1/30 second, a sensitivity of ISO 100, and an aperture size of f/4, (ii) an exposure time of 1/120 second, a sensitivity of ISO 400, and an aperture size of f/4. As another example, an exposure having an exposure value of 16 may be achieved by employing any one of: (i) an exposure time of 1/100 second, a sensitivity of ISO 100, and an aperture size of f/16, (ii) an exposure time of 1/200 second, a sensitivity of ISO 100, and an aperture size of f/11.

It will also be appreciated that the given image is a visual representation of a real-world environment. The term “visual representation” encompasses colour information represented in the given image, and additionally optionally other attributes (for example, such as depth information, luminance information, transparency information (namely, alpha values), polarization information, and the like) associated with the given image.

Optionally, the at least one processor is configured to receive the input sequence of images from the at least one camera itself. Optionally, the at least one processor is configured to control the at least one camera to capture the input sequence of images. The images of the input sequence are received by the at least one processor in real time or near-real time. The input sequence of images optionally comprises at least two images.

Optionally, the images of the input sequence are received in a raw data format, and wherein one or more processing steps of the method are performed in a raw data domain. A technical benefit of using the raw data format is that it provides highest level of visual detail in the images of the input sequence, so it provides most accurate information for processing operations involving said images. Furthermore, the raw data format retains more highlight and shadow detail as compared to other formats, which is crucial for ensuring precision, enhancing flexibility, and minimizing noise and artifacts when generating HDR images.

Throughout the present disclosure, the term “hallucination technique” refers to an image processing technique used for generating an image having a given target exposure, when the image processing technique is applied to a corresponding image having a given exposure and being captured using the at least one camera. It is noteworthy that the image having the given target exposure belongs to the hallucinated set because said image is synthetically generated upon applying the hallucination technique on the corresponding image, rather than being directly captured by the at least one processor. Moreover, the image belonging to the hallucinated set and the corresponding image of the input sequence represent a same real-world scene, but have different exposures which allows them to be utilised for generating the given HDR image. The term “target exposure” refers to an exposure of an image belonging to the hallucinated set of images. The hallucinated set of images optionally comprises at least one image. In some implementations, the given target exposure is greater than the given exposure. In this regard, the corresponding image can be understood to be captured as a dark image, and the image having the given target exposure can be understood to be generated as a bright image. In other implementations, the given target exposure is less than the given exposure. In this regard, the corresponding image can be understood to be captured as a bright image, and the image having the given target exposure can be understood to be generated as a dark image.

Throughout the present disclosure, the term “high-dynamic range image” refers to an image having HDR characteristics. A given HDR image represents a real-world scene being captured using a broader range of brightness levels, as compared to a standard image. Thus, the real-world scene is represented in a highly accurate and realistic manner, as visual details in both dark areas and bright areas of the real-world scene are preserved in the given HDR image. Optionally, the at least one processor is configured to process the given HDR image to generate an XR image, to be shown to a user of the HMD device.

Optionally, when generating a given HDR image in the output sequence, the first neural network performs at least one operation on at least the previously-generated HDR image, and the one of: the corresponding image from the hallucinated set, the corresponding image from the input sequence, that provides a result that is similar to applying at least one HDR imaging technique. The at least one HDR imaging technique may, for example, be an HDR tone-mapping technique, an HDR exposure bracketing technique, an HDR exposure fusion technique, a dual ISO technique, an edge-preserving filtering technique (for example, such as a guided image filtering technique), a multi-layer pyramid fusion technique. The aforesaid HDR imaging techniques and their utilisation for generating HDR images are well-known in the art.

It will be appreciated that a first HDR image in the output sequence of HDR images may be generated in a slightly different manner, as compared to subsequent HDR images (for example, a second HDR image, a third HDR image, a fourth HDR image, and so on), because there will be no previously-generated HDR image in a case when the first HDR image is to be generated. Optionally, in this regard, the at least one processor is configured to employ the first neural network to generate the first HDR image using at least a first image from the hallucinated set and a first image from the input sequence. Alternatively, the first HDR image can be generated using an actual HDR mode of an image sensor of the at least one camera, i.e., by combining two or more images captured using the at least one camera into one HDR image, or by initialising the first HDR image using a predefined image. Such a predefined image could, for example, be an all-black image (when pixel values of all pixels in the predefined image are set to 0), an all-white image (when pixel values of all pixels in the predefined image are set to 1), or a grayscale image (when a pixel value of each pixel in the predefined image is set, for example, to 18 percent of a maximum brightness value). As new images are captured over time, an HDR output can be refined over time by incorporating real image data. The predefined image may not impact the output sequence of HDR images because this process can gradually correct and improve end result. This means that exact visual content of the first HDR frame may not be critical, as subsequently-captured images will provide more accurate HDR results.

Optionally, the step of applying the hallucination technique on the one or more images is performed by employing a second neural network. Optionally, in this regard, an input of the second neural network comprises the one or more images of the input sequence, and an output of the second neural network comprises the hallucinated set of images. A technical benefit of employing the second neural network for applying the hallucination technique is that it provides high-quality, adaptive, and realistic hallucination results, as compared to conventional tone mapping or exposure fusion techniques. The second neural network is adept at handling complex scenarios, for producing realistic and natural hallucination results. For example, the second neural network learns intricate relationships between shadow and well-lit areas in the images of the input sequence, for generating the hallucinated set of images. Furthermore, the second neural network can handle hallucinations for a diverse variety of scenes (for example, such as a high contrast visual scene, a low-light visual scene) in the one or more images of the input sequence without requiring scene-specific tuning. The second neural network also ensures exposure consistency across the one or more images of the input sequence, reducing undesirable flickering effects. It will be appreciated that the second neural network can be trained to perform multiple tasks essential for processing and enhancing image quality. For example, it can align frames to ensure proper synchronization, merge or fuse multiple images to create a high dynamic range (HDR) frame, and perform additional operations such as denoising, super-resolution, and contrast adjustments. Furthermore, it is capable of handling raw-to-RGB conversion, including demosaicking, and can also execute neural fill operations to address missing or incomplete data in the image.

Optionally, the second neural network is trained to enhance low-light images by effectively simulating brighter exposures, whilst preserving colour fidelity and minimizing noise in resulting HDR images. In this regard, when dark images that are captured under low-light conditions are fed to the second neural network, it adjusts their brightness levels dynamically to ensure that shadow details are accurately reconstructed without introducing overexposure artifacts. Additionally, the second neural network may employ colour correction techniques to restore natural and vivid colours that may otherwise appear muted or distorted in low-light scenarios. Beneficially, this ensures that hallucinated images not only achieve the target exposure but also maintain a balanced and realistic colour representation, enhancing an overall visual quality of the generated HDR images. Furthermore, the second neural network is optionally trained to learn intricate relationships between luminance and chrominance in images captured under low-light conditions, enabling it to handle challenging scenarios such as high-contrast scenes or environments with mixed lighting conditions. In this way, it could be ensured that even significantly dark regions of images captured by the at least one camera, are enhanced to reveal fine details, whilst maintaining consistency in brightness and colour across the hallucinated set of images. This capability is particularly beneficial in implementations where only dark images are captured, as it allows generation of high-quality HDR images without requiring additional bright exposures. This has been discussed later in detail.

Optionally, a given neural network is any one of: a recurrent neural network (RNN), a U-net type neural network, an autoencoder, a pure Convolutional Neural Network (CNN), a Residual Neural Network (ResNet), a Vision Transformer (ViT), a neural network having self-attention layers, a diffusion neural network, a generative adversarial network (GAN). All the aforesaid types of neural networks are well-known in the art. The term “given neural network” encompasses at least one of: the first neural network, the second neural network.

Optionally, the second neural network applies an effective exposure ratio to increase exposure in the images of the hallucinated set, the effective exposure ratio being a ratio of the target exposure to one or more exposures of the one or more images, and wherein the effective exposure ratio lies in a range of 2 to 64. Optionally, in this regard, the input of the second neural network further comprises the effective exposure ratio. The effective exposure ratio indicates how much an exposure of the one or more images needs to be adjusted (i.e., increased) from one or more original exposure levels to reach the target exposure. Greater the effective exposure ratio, greater is the difference between the target exposure to the one or more exposures of the one or more images, and vice versa. In other words, a higher effective exposure ratio corresponds to a greater difference between the target exposure and the original exposure of the images, while a lower effective exposure ratio indicates a smaller difference. The ratio of the target exposure to the one or more exposures can be understood to be a ratio of a hallucinated exposure to an actual short-exposure. The effective exposure ratio can be understood to be a scaling factor which is applied to increase the exposure of the one or more images. This ensures that in the images of the hallucinated set are adjusted to appropriate brightness level before being used in HDR image generation, leading to balanced and natural-looking visual details. It will be appreciated that when the effective exposure ratio lies in the range of 2 to 64, excessive exposure amplification (which could introduce artifacts or noise) can be mitigated. A technical effect of applying the effective exposure ratio is that the second neural network can effectively simulate large exposure ratios that are beyond physical limits of an image sensor of the at least one camera. The second neural network enables fine-grained control over the effective exposure ratio. Utilising the effective exposure ratio ensures consistent brightness across hallucinated images, improving HDR quality. It may also prevent overexposure artifacts by maintaining the effective exposure ratio within a controlled range (from 2 to 64, as described above). It may also enhance detail preservation in both shadow and highlight areas, resulting in generation of visually-balanced HDR images.

Optionally, the method further comprises:
determining at least one of:
   a region of interest in the one or more images, based on gaze-tracking data collected by a gaze tracker,
   lighting conditions in the one or more images, based on at least one of: an image analysis technique, sensor data collected by a light sensor arranged in an operational environment of the at least one camera; and
selecting the effective exposure ratio based on the at least one of: the region of interest, the lighting conditions.

The term “gaze tracker” refers to specialized equipment for detecting and/or following a gaze of a given eye of a given user. The gaze tracker could be implemented as contact lenses with sensors, cameras monitoring a position, a size, and/or a shape of a pupil of a user's eye, and the like. Examples of gaze trackers are well-known in the art. The gaze tracker monitors movements of the given eye, and collects the gaze-tracking data. The gaze-tracking data may comprise images/videos of the given eye of the given user, sensor values, and the like. The term “region of interest” refers to a region of the one or more images where the gaze is directed. In other words, the region of interest is understood to be a gaze-contingent region in the one or more images at which the user is looking or is going to look. Optionally, when determining the region of interest, the at least one processor is configured to map the gaze of the given eye of the given user onto the one or more images. Since the region of interest is as an important region to be presented to the given user, the effective exposure ratio would be carefully selected such that the region of interest is well-exposed in the one or more images. This ensures that important image details are well preserved at least in the region of interest of the one or more images. In an example, when the region of interest is dark, a higher effective exposure ratio is selected to increase brightness.

Further, for determining the lighting conditions in the one or more images, the image analysis technique enables in ascertaining brightness levels, contrast levels, and a dynamic range across different portions of the one or more images. In this regard, dark or overexposed areas of the one or more images are identified to understand how much exposure adjustment is needed for enhancing visibility in the dark or overexposed areas, while preventing overexposure in brighter areas of the one or more images.

Additionally, the light sensor, in operation, senses/detects ambient lighting conditions of the operational environment. Examples of the light sensor include, but are not limited to, an ambient light sensor, a lidar sensor. When the light sensor detects a low-light condition in the operational environment, the at least one processor ascertains that images captured by the at least one camera are likely underexposed and the effective exposure ratio is to be increased accordingly. However, when the light sensor detects a bright-light condition in the operational environment, the at least one processor ascertains that images captured by the at least one camera are likely overexposed (or may be normally-exposed) and the effective exposure ratio is to be decreased accordingly, such that exposure adjustments do not result in overexposure or loss of details in highlights in the images of the hallucinated set. In these ways, the system and the method dynamically adapts to different lighting scenarios, leading to more precise HDR image generation.

A technical effect of utilising the region of interest and/or the lighting conditions for a dynamic adjustment of the effective exposure ratio is that it ensures high-quality, low-noise HDR imaging across a variety of operational conditions. This is possible because when the effective exposure ratio is adjusted according to the region of interest, it enables capturing of accurate and sufficient visual detail in the region of interest, in the output sequence of HDR images. Furthermore, when the effective exposure ratio is adjusted according to the lighting conditions, an optimal HDR performance is achieved, irrespective of the operational conditions.

Optionally, the method further comprises selecting the one or more images of the input sequence upon which the hallucination technique is to be applied, as those images which are captured using an exposure that is less than a predefined threshold, wherein the predefined threshold is less than or equal to the target exposure. In this regard, the images captured using the exposure that is less than the predefined threshold can be understood to be captured as dark images (namely, underexposed images). Since such images often lacks sufficient brightness and visual detail in dark areas of the images, the hallucination technique would be applied to said images in order to generate corresponding bright images (namely, images belonging the hallucinate set) having the target exposure. It will be appreciated that the hallucination technique would not be applied on those images which are captured using an exposure that is greater than the predefined threshold, because such images already have sufficient brightness and visual detail in well-lit areas of the images. Applying the hallucination technique to these images would be unnecessary and may be potentially detrimental, as it could introduce artifacts or alter correctly exposed visual details. Optionally, the predefined threshold lies in a range of −1 exposure value (EV) to 1 EV. More optionally, the predefined threshold lies in a range of −6 EV to 0 EV.

Optionally, the input sequence of images comprises:
a first set of images captured using a first exposure lying within a first exposure range, and
a second set of images captured using a second exposure lying within a second exposure range, wherein the images of the first set are interleaved with the images of the second set, in the input sequence,
   wherein at least one of: the first exposure, the second exposure is less than the predefined threshold, and at least one of: the images of the first set, the images of the second set, are selected as the one or more images.

In this regard, in some implementations, when the first exposure is less than the predefined threshold, the images of the first set are selected as the one or more images (as the images of the first set can be understood to be captured as dark images), and the hallucinated technique is applied to the images of the first set. In other implementations, when the second exposure is less than the predefined threshold, the images of the second set are selected as the one or more images (as the images of the second set can be understood to be captured as dark images), and the hallucinated technique is applied to the images of the second set. In yet other implementations, when both the first exposure and the second exposure are less than the predefined threshold, the images of both the first set and the second set are selected as the one or more images, and the hallucinated technique is applied to the images of both the first set and the second set.

It will be appreciated that the at least one camera is controlled to switch between the first exposure and the second exposure to capture the images of the first set and the images of the second set. Optionally, the first exposure range is one of: a short exposure range, a long exposure range, while the second exposure range is another of: the short exposure range, the long exposure range. Optionally, the short exposure range lies from 100 microseconds to 8 milliseconds, while the long exposure range lies from 1 millisecond to 16 milliseconds. In some implementations, the at least one camera is controlled to capture the images of the first set and the images of the second set in an alternating interleaving manner. In such implementations, the images of the first set and the second set can be captured as follows:
short exposure image, long exposure image, short exposure image, long exposure image, and so on . . .
or
long exposure image, short exposure image, long exposure image, short exposure image, and so on . . .

In other implementations, the at least one camera is controlled to capture the images of the first set and the images of the second set in a regular sparse interleaving manner. In such implementations, the images of the first set and the second set can be captured as follows:
short exposure image, short exposure image, long exposure image, short exposure image, short exposure image, long exposure image, and so on . . .

There could also be other different ways to capture the images of the first and second sets in the regular sparse interleaving manner than that described above.

In an embodiment, the method further comprises controlling the at least one camera such that both the first exposure and the second exposure are less than the predefined threshold. In this regard, when the at least one camera is controlled in the aforesaid manner, an image capturing pipeline of the at least one camera is simplified. This is because significant exposure switching is not required as both the first exposure and the second exposure are less than the predefined threshold, i.e., both the images of the first set and the images of the second set can be understood to be captured as dark images. Thus, the at least one camera could maintain a frame rate of capturing the images that easily matches with a frame rate of generating the output sequence of HDR images. Moreover, when the first exposure and the second exposure are less than the predefined threshold, the hallucination technique would be applied to both the images of the first set and the images of the second set, as these images can be understood to be captured as the dark images. Upon applying the hallucination technique, brightness levels and other visual details of these images are considerably improved, especially in dark areas of said images. This is because hallucinating images simulate a bright exposure (i.e., the target exposure) which reduces a noise, a graininess, and a motion blur in said images.

It will be appreciated that in the aforesaid implementation where only the dark images are captured, the second neural network plays a critical role in enhancing brightness and restoring colour fidelity. By applying the hallucination technique, the second neural network dynamically adjusts brightness levels of underexposed images to simulate brighter exposures, ensuring that shadow details are accurately reconstructed. Additionally, the second neural network performs advanced colour correction to restore natural and vivid colors, even in challenging low-light conditions. This process minimizes noise and graininess, which are common in underexposed images, while maintaining a balanced and realistic colour representation in resulting HDR images. Furthermore, the second neural network's ability to learn complex relationships between luminance and chrominance in images captured under low-light scenarios allows it to handle extreme exposure adjustments without introducing any artifacts. This ensures that the hallucinated images not only achieve the target exposure but also exhibit consistent brightness and colour across image frame, which is crucial for generating high-quality HDR images. Furthermore, the second neural network's processing pipeline is optimized to handle these enhancements in a computationally efficient manner, enabling real-time or near-real-time HDR image generation without compromising performance.

In an alternative embodiment, the method further comprises controlling the at least one camera such that the first exposure is less than the predefined threshold while the second exposure is greater than or equal to the predefined threshold. In this regard, when the at least one camera is controlled in the aforesaid manner, both dark images (i.e., the images of the first set) and bright images (i.e., the images of the second set) would be generated in the interleaving manner. When such images of different exposure levels are utilised for generating the HDR images in the output sequence, the generated HDR images would have a wide dynamic range which effectively captures both low-light detail (i.e., shadows) and bright-light detail (i.e., highlights), minimal or nil motion blur and noise, and accurate colour reproduction. Since the first exposure is less than the predefined threshold, the hallucination technique is applied on the images of the first set. Furthermore, as the images of the second set are captured using the second exposure, the hallucination technique need not be applied on the images of the second set, and thus a computational burden on the at least one processor is likely reduced.

Optionally, the method further comprises merging one or more images from the second set into one or more images of the hallucinated set, prior to the step of generating the output sequence of HDR images. In this regard, when the hallucinated technique is applied on one or more images of the first set (which are captured using the first exposure that is less than the predefined threshold), the one or more images of the hallucinated set (generated corresponding to the one or more images of the first set) would have a bright exposure (i.e., the target exposure) but also have a noise. In such a case, it is not beneficial to utilise the one or more images of the hallucinated set for generating the HDR images. In order to mitigate the noise, the one or more images from the second set are merged into the one or more images of the hallucinated set. Using the one or more images of the second set for the aforesaid merging is beneficial because the one or more images in the second set would already have a bright exposure as they are captured using the second exposure that is greater than or equal to the predefined threshold. Beneficially, this allows for a reduction of the noise in the one or more images of the of the hallucinated set (i.e., hallucinated long-exposure images). Upon merging, one or more merged images of a resulting merged set can be utilised for generating the HDR images. It will be appreciated that for performing the aforesaid merging, the one or more images from the second set is optionally fed as an additional input to the first neural network, wherein the first neural network performs the aforesaid merging via a concatenation operation.

Optionally, the method further comprises applying the hallucination technique on the first set of images, for generating a third set of images corresponding to at least one intermediate exposure that lies between the first exposure and the second exposure,
wherein at the step of generating the output sequence of HDR images, each HDR image in the output sequence is generated using also one or more images from the third set.

A technical effect of using the one or more images from the third set for generating the HDR images is that the one or more images of the third set have balanced visual details in both highlights and shadows areas, as compared to the images of the first set (having a dark exposure) and the images of the second set (having a bright exposure). Thus, utilising the one or more images of the third set can enhance an overall visual quality of the HDR images, whilst reducing a need for extreme adjustments (for example, such as requiring less aggressive tone mapping, exposure correction, and visual detail reconstruction to balance bright and dark areas in a given HDR image). This is possible because the third set of images already comprise well-balanced visual details in both highlights and shadows areas, thus the first neural network may not have to artificially brighten dark areas or recover lost details from overexposed regions, resulting into realistic HDR images with negligible artifacts. Furthermore, the images of the third set enables compatibility with legacy (i.e., existing) multi-frame HDR algorithms that require multiple exposures for generating the output sequence of HDR images. It is to be understood that the hallucination technique is applied to the first set of images but not to the second set of images because underexposed images generally lack complete visual details in shadow areas, while overexposed images generally retain some visual details in bright areas.

Optionally, the at least one camera comprises a first camera and a second camera that collectively form a stereo imaging pair, the first camera and the second camera being controlled to capture a first sequence of images and a second sequence of images, respectively, at a same rate, such that the first camera and the second camera use different exposures from amongst the first exposure and the second exposure while capturing corresponding images of the first sequence and the second sequence. In this regard, when the first camera is controlled to capture an image using the first exposure (that is less than the predefined threshold), the second camera is controlled to capture a corresponding image using the second exposure (that is greater than or equal to the predefined threshold), and when the first camera is controlled to capture another image using the second exposure, the second camera is controlled to capture a corresponding image using the first exposure. It will be appreciated that for the stereo imaging pair, a first output sequence of HDR images is generated corresponding to the first camera, and a second output sequence of HDR images is generated corresponding to the second camera in a similar manner as the output sequence of HDR images is generated. In some implementations, the first output sequence of HDR images and the second output sequence of HDR images are generated by employing the first neural network, i.e., a single neural network. In other implementations, the first output sequence of HDR images and the second output sequence of HDR images are generated by employing two different neural networks.

A technical benefit of using the stereo imaging pair is that the stereo imaging pair captures complementary exposures simultaneously from slightly offset viewing locations, and enable both a dynamic range and depth information to be effectively captured at a same time. The depth information enhances an accuracy of simulating bright details when subsequently applying the hallucination technique on the first sequence of images and/or the second sequence of images. This improves an overall visual quality of the generated HDR images. Furthermore, in such a case, the stereo imaging pair achieves consistent temporal coverage without gaps in image data, which reduces temporal artifacts such as a motion blur or a ghosting artefact, in the generated HDR images. This may, particularly, be beneficial when the first camera and the second camera are imaging fast-moving objects in the real-world environment.

In an embodiment, the step of applying the hallucination technique is performed in an alternating manner for a first set of images of the first sequence and a first set of images of the second sequence, using same processing resources. In this regard, for a given stereo pair of images comprising a first image and a second image, the first image is captured using the first exposure (i.e., a dark exposure), while the second image is captured using the second exposure (i.e., a bright exposure). In such cases, the hallucination technique is applied on the first image, but not on the second image. For another given stereo pair of images comprising a third image and a fourth image, the third image is captured using the second exposure, while the fourth image is captured using the first exposure. In such cases, the hallucination technique is applied on the fourth image, but not on the third image. It is to be understood that the first image and third image belong to the first set of images of the first sequence. The second image and fourth image belong to the second set of images of the second sequence. Thus, in this way, the hallucination technique would be performed with respect to a maximum of one sequence of images at a given time, which enables in saving processing resource of the at least one processor.

In an alternative embodiment, the step of applying the hallucination technique is performed only for a first set of images of the first sequence, and wherein the method further comprises reprojecting a fourth set of images, generated upon applying the hallucination technique on the images of the first set of the first sequence, from a perspective of the second camera, wherein the reprojected fourth set of images is utilized when implementing the step of generating the output sequence of HDR images corresponding to the second camera. In this regard, instead of applying the hallucination technique in the alternating manner as described earlier, the hallucination technique is instead applied only on the first set of images of the first sequence to generate the fourth set of images. Optionally, when reprojecting the images of the fourth set from (a perspective of) a pose of the first camera to (a perspective of) a pose of the second camera, the least one processor is configured to employ at least one image reprojection algorithm. The at least one image reprojection algorithm comprises at least one space warping algorithm. Image reprojection algorithms are well-known in the art. Since images captured by the first camera and the second camera represent slightly offset views of a same real-world scene, reprojecting the images of the fourth set would be beneficial because it allows the generation of HDR images corresponding to the pose of the second camera without requiring performing the hallucination technique on images captured by the second camera. Instead, the (hallucinated) images corresponding to the pose of the first camera are transformed to match the pose of the second camera, ensuring consistency in exposure balancing and visual detail reconstruction across both the first camera and the second camera.

A technical benefit of such an approach is that it facilitates in reducing a computational overhead by avoiding redundant hallucination processing while still providing different exposure images for HDR image generation. Additionally, using reprojection ensures that scene geometry and depth relationships are preserved, minimizing artifacts that could arise from independently hallucinating images for each camera. Moreover, in such an approach, the processing resources required for implementing the step of applying the hallucination technique can be shared between two stereo imaging pairs. Furthermore, the images of the reprojected fourth set may be optionally analysed with respect to corresponding images of the second sequence, for enabling correction of parallax errors and providing stereo consistency across the stereo imaging pair.

The present disclosure also relates to the system as described above. Various embodiments and variants disclosed above, with respect to the aforementioned first aspect, apply mutatis mutandis to the system.

Optionally, in the system, the predefined threshold lies in a range of −1 exposure value (EV) to 1 EV.

Optionally, in the system, the input sequence of images comprises:
a first set of images captured using a first exposure lying within a first exposure range, and
a second set of images captured using a second exposure lying within a second exposure range, wherein the images of the first set are interleaved with the images of the second set, in the input sequence,
   wherein at least one of: the first exposure, the second exposure is less than the predefined threshold, and at least one of: the images of the first set, the images of the second set, are selected as the one or more images.

Optionally, the at least one processor is configured to control the at least one camera such that both the first exposure and the second exposure are less than the predefined threshold.

Alternatively, optionally, the at least one processor is configured to control the at least one camera such that the first exposure is less than the predefined threshold while the second exposure is greater than or equal to the predefined threshold.

Optionally, the at least one processor is configured to merge one or more images from the second set into one or more images of the hallucinated set, prior to generating the output sequence of HDR images.

Optionally, the at least one processor is configured to apply the hallucination technique on the first set of images, for generating a third set of images corresponding to at least one intermediate exposure that lies between the first exposure and the second exposure,

wherein when generating the output sequence of HDR images, each HDR image in the output sequence is generated using also one or more images from the third set.

Optionally, the at least one camera comprises a first camera and a second camera that collectively form a stereo imaging pair, the first camera and the second camera being controlled to capture a first sequence of images and a second sequence of images, respectively, at a same rate, such that the first camera and the second camera use different exposures from amongst the first exposure and the second exposure while capturing corresponding images of the first sequence and the second sequence.

Optionally, the hallucination technique is applied in an alternating manner for a first set of images of the first sequence and a first set of images of the second sequence, using same processing resources.

Alternatively, optionally, the hallucination technique is applied for a first set of images of the first sequence, wherein the at least one processor is configured to reproject a fourth set of images, generated upon applying the hallucination technique on the images of the first set of the first sequence, from a perspective of the second camera, wherein the reprojected fourth set of images is utilized, when generating the output sequence of HDR images corresponding to the second camera.

Optionally, the at least one processor is configured to apply the hallucination technique on the one or more images by employing a second neural network.

Optionally, the second neural network applies an effective exposure ratio to increase exposure in the images of the hallucinated set, the effective exposure ratio being a ratio of the target exposure to one or more exposures of the one or more images, and wherein the effective exposure ratio lies in a range of 2 to 64.

Optionally, the at least one processor is configured to:
determine at least one of:
   a region of interest in the one or more images, based on gaze-tracking data collected by a gaze tracker,
   lighting conditions in the one or more images, based on at least one of: an image analysis technique, sensor data collected by a light sensor arranged in an operational environment of the at least one camera; and
select the effective exposure ratio based on the at least one of: the region of interest, the lighting conditions.

Optionally, the images of the input sequence are received in a raw data format, wherein the at least one processor is configured to perform one or more processing steps of the system in a raw data domain.

### Detailed Description of the Drawings

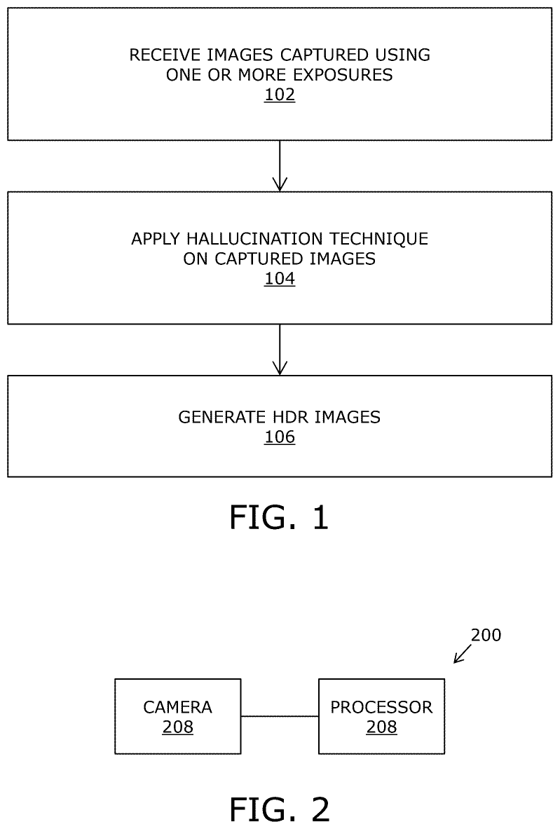

Referring to FIG. 1, illustrated are steps of a method for multi-exposure high dynamic range (HDR) imaging, in accordance with an embodiment of the present disclosure. At step 102, an input sequence of images captured by at least one camera, is received, wherein the images of the input sequence are captured using one or more exposures. At step 104, a hallucination technique is applied on one or more images of the input sequence, for generating a hallucinated set of images corresponding to a target exposure that lies within a target exposure range. At step 106, an output sequence of HDR images is generated at a same frame rate with which the input sequence is captured, by employing a first neural network, each HDR image in the output sequence being generated using at least a previously-generated HDR image and one of: a corresponding image from the hallucinated set, a corresponding image from the input sequence.

The aforementioned steps are only illustrative and other alternatives can also be provided where one or more steps are added, one or more steps are removed, or one or more steps are provided in a different sequence without departing from the scope of the claims herein.

Referring to FIG. 2, illustrated is a block diagram of a system 200 for multi-exposure high dynamic range (HDR) imaging, in accordance with an embodiment of the present disclosure. The system 200 comprises at least one camera (depicted as a camera 202) and at least one processor (depicted as a processor 204) communicably coupled to the camera 202. The camera 202 captures an input sequence of images using one or more exposures. The processor 204 is configured to implement the steps of the aforementioned method as described in FIG. 1.

It may be understood by a person skilled in the art that FIG. 2 includes a simplified a block diagram of the system 200, for sake of clarity, which should not unduly limit the scope of the claims herein. It is to be understood that a specific implementation of the system 200 is not to be construed as limiting it to specific numbers or types of cameras and processor. The person skilled in the art will recognize many variations, alternatives, and modifications of embodiments of the present disclosure.

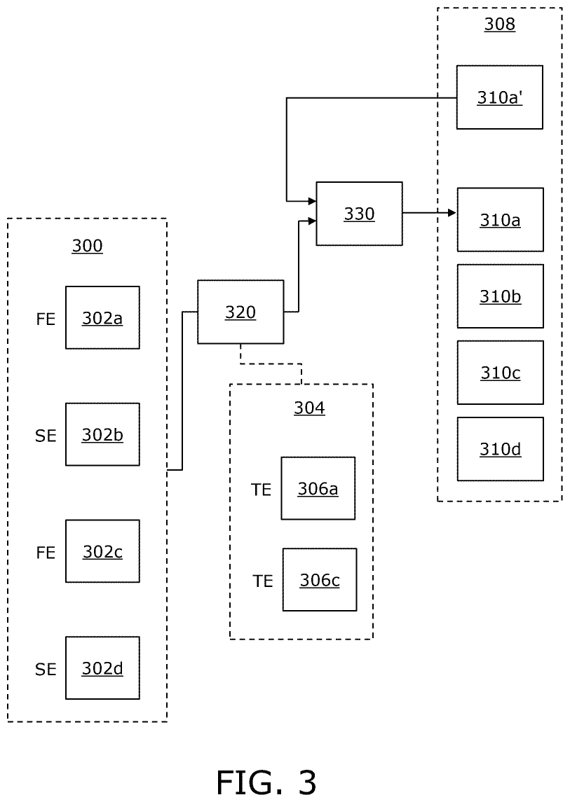

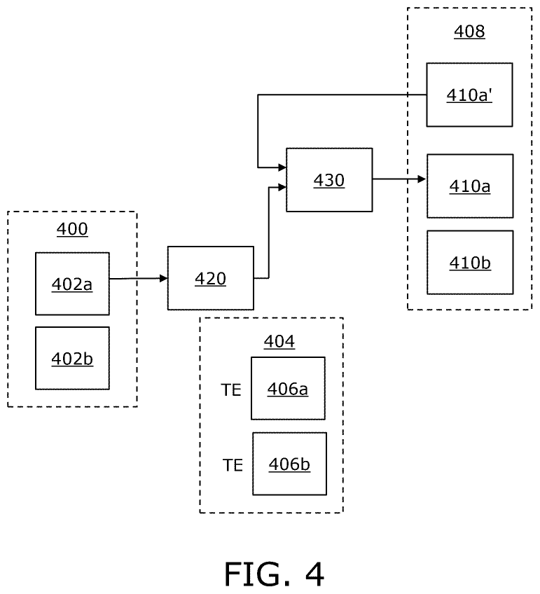

Referring to FIGS. 3, 4, and 5, illustrated are exemplary implementations of the method for multi-exposure high dynamic range (HDR) imaging, in accordance with various embodiments of the present disclosure. Each of these implementations will be discussed in detail separately.

In FIG. 3, there is shown an input sequence 300 of images captured by at least one camera (not shown), wherein the images of the input sequence 300 are captured using one or more exposures. For sake of simplicity and clarity, the input sequence 300 is shown to comprise four images. The input sequence 300 comprises a first set of images 302a and 302c captured using a first exposure FE lying within a first exposure range, and a second set of images 302b and 302d captured using a second exposure SE lying within a second exposure range. The images 302a and 302c of the first set are interleaved with the images 302b and 302d of the second set, in the input sequence 300. Let us consider, for example, that in the embodiment of FIG. 3, the first exposure FE is less than a predefined threshold while the second exposure SE is greater than or equal to the predefined threshold. In other words, the images 302a and 302c of the first set are dark images, whereas the images 302b and 302d of the second set are bright images.

Notably, a hallucination technique is applied on the images 302a and 302c of the first set, for generating a hallucinated set 304 of images corresponding to a target exposure TE that lies within a target exposure range. Optionally, the hallucination technique is applied on the images 302a and 302c by employing a second neural network 320. The hallucinated set 304 of images comprises, for example, an image 306a corresponding to the image 302a, and an image 306c corresponding to the image 302c. It is to be understood that the images 306a and 306c are understood to be hallucinated images.

Next, an output sequence 308 of HDR images is generated at a same frame rate with which the input sequence 300 is captured, by employing a first neural network 330. Each HDR image in the output sequence 308 is generated using at least a previously-generated HDR image and one of: a corresponding image from the hallucinated set 304, a corresponding image from the input sequence 300. For example, an HDR image 310a may be generated using a previously-generated HDR image 310a′ and the image 306a from the hallucinated set 304; an HDR image 310b may be generated using a previously-generated HDR image (for example, the HDR image 310a) and the image 302b from the input sequence 300; an HDR image 310c may be generated using a previously-generated HDR image (for example, the HDR image 310b) and the image 306c from the hallucinated set 304; and an HDR image 310d may be generated using a previously-generated HDR image (for example, the HDR image 310c) and the image 302d from the input sequence 300.

In case the previously-generated HDR image is unavailable (for example, when a first image of the input sequence 300 is being processed), a first HDR image of the output sequence 308 may be generated using said first image of the input sequence 300 and a corresponding image from the hallucinated set 304. For example, if the previously-generated HDR image 310a′ was unavailable, the HDR image 310a may be generated using the image 302a and the image 306a.

In FIG. 4, there is shown an input sequence 400 of images captured by at least one camera (not shown), wherein the images of the input sequence 400 are captured using one or more exposures. For sake of simplicity and clarity, the input sequence 400 is shown to comprise two images 402a and 402b. Let us consider, for example, that in the embodiment of FIG. 4, each of the images 402a and 402b is captured using an exposure that is less than a predefined threshold, wherein the predefined threshold is less than or equal to a target exposure TE. In other words, each of the images 402a and 402b are dark images.

Notably, a hallucination technique is applied on both the images 402a and 402b, for generating a hallucinated set 404 of images corresponding to the target exposure TE that lies within a target exposure range. Optionally, the hallucination technique is applied on the images 402a and 402b by employing a second neural network 420. The hallucinated set 404 of images comprises, for example, an image 406a corresponding to the image 402a, and an image 406b corresponding to the image 402b. It is to be understood that the images 406a and 406b are understood to be hallucinated images.

Next, an output sequence 408 of HDR images is generated at a same frame rate with which the input sequence 400 is captured, by employing a first neural network 430. Each HDR image in the output sequence 408 is generated using at least a previously-generated HDR image and one of: a corresponding image from the hallucinated set 404, a corresponding image from the input sequence 400. For example, an HDR image 410a may be generated using a previously-generated HDR image 410a′ and the image 406a from the hallucinated set 404; and an HDR image 410b may be generated using a previously-generated HDR image (for example, the HDR image 410a) and the image 406b from the hallucinated set 404.

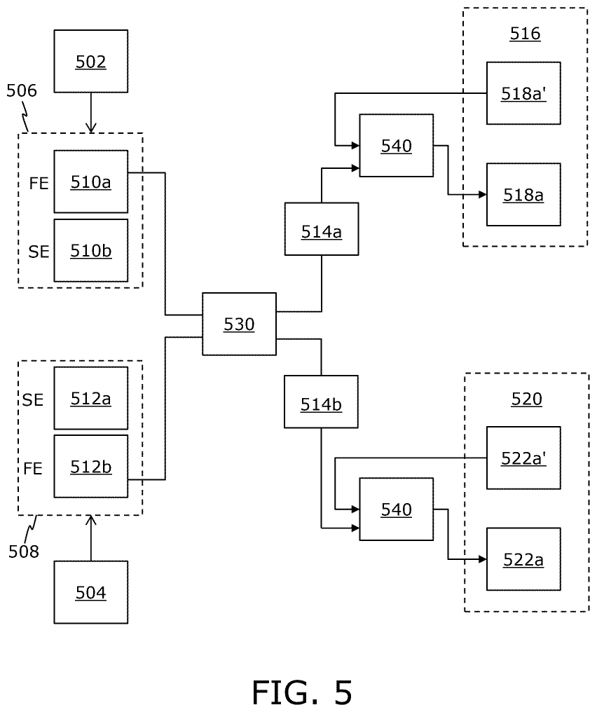

In FIG. 5, there is shown a stereo imaging pair formed by a first camera 502 and a second camera 504 collectively. The first camera 502 and the second camera 504 are controlled to capture a first sequence 506 of images and a second sequence 508 of images, respectively, at a same rate, such that the first camera 502 and the second camera 504 use different exposures from amongst a first exposure FE and a second exposure SE while capturing corresponding images of the first sequence 506 and the second sequence 508. This means that when the first camera 502 uses the first exposure FE to capture an image 510a (belonging to the first sequence 506), the second camera 504 uses the second exposure SE to capture a corresponding image 512a (belonging to the second sequence 508), and when the first camera 502 uses the second exposure SE to capture another image 510b (belonging to the first sequence 506), the second camera 504 uses the first exposure FE to capture another corresponding image 512b (belonging to the second sequence 508).

Let us consider, for example, that the images 510a and 512a constitute a currently-captured set of stereo images, wherein the first exposure FE is less than a predefined threshold while the second exposure SE is greater than or equal to the predefined threshold. This means that the image 510a is a dark image and the image 512a is a bright image. In this example, a hallucination technique is applied on the image 510a, optionally, by a second neural network 530, to generate a corresponding image 514a having a target exposure. It is to be understood that the corresponding image 514a is understood to be a hallucinated image. There is no need for applying the hallucination technique on the image 512a. Similarly, the images 510b and 512b constitute a next-captured set of stereo images, wherein the image 512b is a dark image and the image 510b is a bright image. In such a case, the hallucination technique is applied on the image 512b, optionally, by the second neural network 530, to generate a corresponding image 514b having a target exposure. It is to be understood that the corresponding image 514b is understood to be a hallucinated image. There is no need for applying the hallucination technique on the image 510b. Thus, it can be inferred that the step of applying the hallucination technique is performed in an alternating manner for a first set of images (which comprises the image 510a, for sake of simplicity) of the first sequence 506 and a first set of images (which comprises the image 512b, for sake of simplicity) of the second sequence 508, using same processing resources (for example, depicted as the second neural network 530).

Further, when generating an output sequence 516 of HDR images corresponding to the first camera 502, an HDR image 518a is generated using a previously-generated HDR image 518a′ and the image 514a. When generating an output sequence 520 of HDR images corresponding to the second camera 504, an HDR image 522a is generated using a previously-generated HDR image 522a′ and the image 514b. Alternatively, the HDR image 522a could also be generated using the previously-generated HDR image 522a′ and the image 512a. However, this alternative case is not shown in the FIG. 5, for sake of simplicity and avoiding any confusion. As shown, in some implementations, both the output sequences 516 and 520 of HDR images are generated by employing a first neural network 540. However, in other implementations, the output sequences 516 and 520 of HDR images may be generated by employing different neural networks (not shown in FIG. 5, for sake of simplicity and avoiding any confusion).

FIGS. 3, 4, and 5 are merely examples, which should not unduly limit the scope of the claims herein. A person skilled in the art will recognize many variations, alternatives, and modifications of embodiments of the present disclosure.

1. A method for multi-exposure high dynamic range (HDR) imaging, the method comprising:
receiving an input sequence of images captured by at least one camera, wherein the images of the input sequence are captured using one or more exposures;
applying a hallucination technique on one or more images of the input sequence, for generating a hallucinated set of images corresponding to a target exposure that lies within a target exposure range; and
generating an output sequence of HDR images at a same frame rate with which the input sequence is captured, by employing a first neural network, each HDR image in the output sequence being generated using at least a previously-generated HDR image and one of: a corresponding image from the hallucinated set, a corresponding image from the input sequence.

2. The method of claim 1, further comprising selecting the one or more images of the input sequence upon which the hallucination technique is to be applied, as those images which are captured using an exposure that is less than a predefined threshold, wherein the predefined threshold is less than or equal to the target exposure.

3. The method of claim 2, wherein the predefined threshold lies in a range of −1 exposure value (EV) to 1 EV.

4. The method of claim 2, wherein the input sequence of images comprises:
a first set of images captured using a first exposure lying within a first exposure range, and
a second set of images captured using a second exposure lying within a second exposure range, wherein the images of the first set are interleaved with the images of the second set, in the input sequence,
wherein at least one of: the first exposure, the second exposure is less than the predefined threshold, and at least one of: the images of the first set, the images of the second set, are selected as the one or more images.

5. The method of claim 4, further comprising controlling the at least one camera such that both the first exposure and the second exposure are less than the predefined threshold.

6. The method of claim 4, further comprising controlling the at least one camera such that the first exposure is less than the predefined threshold while the second exposure is greater than or equal to the predefined threshold.

7. The method of claim 6, further comprising merging one or more images from the second set into one or more images of the hallucinated set, prior to the step of generating the output sequence of HDR images.

8. The method of claim 6, further comprising applying the hallucination technique on the first set of images, for generating a third set of images corresponding to at least one intermediate exposure that lies between the first exposure and the second exposure,
wherein at the step of generating the output sequence of HDR images, each HDR image in the output sequence is generated using also one or more images from the third set.

9. The method of claim 6, wherein the at least one camera comprises a first camera and a second camera that collectively form a stereo imaging pair, the first camera and the second camera being controlled to capture a first sequence of images and a second sequence of images, respectively, at a same rate, such that the first camera and the second camera use different exposures from amongst the first exposure and the second exposure while capturing corresponding images of the first sequence and the second sequence.

10. The method of claim 9, wherein the step of applying the hallucination technique is performed in an alternating manner for a first set of images of the first sequence and a first set of images of the second sequence, using same processing resources.

11. The method of claim 9, wherein the step of applying the hallucination technique is performed only for a first set of images of the first sequence, and wherein the method further comprises reprojecting a fourth set of images, generated upon applying the hallucination technique on the images of the first set of the first sequence, from a perspective of the second camera, wherein the reprojected fourth set of images is utilized when implementing the step of generating the output sequence of HDR images corresponding to the second camera.

12. The method of claim 1, wherein the step of applying the hallucination technique on the one or more images is performed by employing a second neural network.

13. The method of claim 12, wherein the second neural network applies an effective exposure ratio to increase exposure in the images of the hallucinated set, the effective exposure ratio being a ratio of the target exposure to one or more exposures of the one or more images, and wherein the effective exposure ratio lies in a range of 2 to 64.

14. The method of claim 13, further comprising:
determining at least one of:
a region of interest in the one or more images, based on gaze-tracking data collected by a gaze tracker,
lighting conditions in the one or more images, based on at least one of: an image analysis technique, sensor data collected by a light sensor arranged in an operational environment of the at least one camera; and
selecting the effective exposure ratio based on the at least one of: the region of interest, the lighting conditions.

15. The method of claim 1, wherein the images of the input sequence are received in a raw data format, and wherein one or more processing steps of the method are performed in a raw data domain.

16. A system for multi-exposure high dynamic range (HDR) imaging, wherein the system comprises:
at least one camera; and
at least one processor configured to:
receive an input sequence of images captured by the at least one camera, wherein the images of the input sequence are captured using one or more exposures;
apply a hallucination technique on one or more images of the input sequence, for generating a hallucinated set of images corresponding to a target exposure that lies within a target exposure range; and
generate an output sequence of HDR images at a same frame rate with which the input sequence is captured, by employing a first neural network, each HDR image in the output sequence being generated using at least a previously-generated HDR image and one of: a corresponding image from the hallucinated set, a corresponding image from the input sequence.
